(19) United States
(12) Patent Application Publication
(10) Pub. No.: US 2008/0200600 A1
(43) Pub. Date: Aug. 21, 2008

(54) Polymer-Containing Composition, its Preparation and Use

(75) Inventors: Elwin Schomaker, Arnhem (NL); Siebe Cornelis De Vos, Arnhem (NL)

Correspondence Address: KENYON & KENYON LLP, ONE BROADWAY, NEW YORK, NY, 10004, US

(73) Assignee: Akzo Nobel N. V., Arnhem (NL)

(21) Appl. No.: 11/630,543

(22) PCT Filed: Jun. 21, 2005
(86) PCT No.: PCT/EP2005/052869

§ 371 Date: Mar. 22, 2007

Related U.S. Application Data
(60) Provisional application No. 60/588,789, filed on Jul. 19, 2004.

(30) Foreign Application Priority Data
Jun. 23, 2004 (EP) 04076822.8

(51) Int. Cl. C08K 3/34

(52) U.S. Cl. 524/445

(57) ABSTRACT

Process for the preparation of a polymer-containing composition comprising the steps of (a) preparing a mixture of an inorganic anionic clay and a cyclic monomer and (b) polymerising said monomer. It has been found that intercalation of the anionic clay with organic anions prior to its use in a polymerisation reaction is not required. Neither is the use of a polymerisation catalyst or initiator.

The present invention relates to a process for the preparation of a polymer-containing composition in the presence of a layered material. More in particular, this process involves ring-opening polymerisation of a cyclic monomer in the presence of a clay. The invention further relates to a composition obtainable by this process, and the use of this composition.

An example of a polymer that can be prepared by ring-opening polymerisation is the aliphatic polyester poly(ε-caprolactone) (PCl). Its synthesis is initiated through a ring-opening reaction in which the carbonyl group of the lactone monomer is attacked by acid, amine, or alcohol. This polymer has a highly crystalline structure and is biodegradable and non-toxic. It is widely used in packaging and medical supplies, including degradable packaging, controlled release of drugs, and orthopaedic casts. Although PCl is readily processable and has good compatibility with other polymers, its low melting point (60° C.) has limited its use in many applications. Thus caprolactone has been blended with other polymers or co-polymerised with other monomers to expand its usage.

In order to improve the properties of polymers, nano-sized particles can be introduced, resulting in so-called polymer-based nanocomposites. In general, the term “nanocomposites” refers to a composite material wherein at least one component comprises an inorganic phase with at least one dimension in the 0.1 to 100 nanometer range. One class of polymer-based nanocomposites (PNC) comprises hybrid organic-inorganic materials derived from the incorporation of small quantities of extremely thin nanometer-sized inorganic particles of high aspect ratio into a polymer matrix. Additions of small amounts of nanoparticles are surprisingly effective in upgrading otherwise mutually exclusive properties of polymers, such as strength and toughness. A major advantage of this class of nanocomposites is that they simultaneously improve material properties which are usually trade-offs. On top of their improved strength-to-weight ratios as compared to polymers filled with conventional mineral fillers, PNCs exhibit improved flame resistance, better high temperature stability, and better dimensional stability. In particular, a significant reduction of the coefficient of expansion is of practical interest in automotive applications. Improved barrier properties and transparency are unique assets of nanocomposites, e.g., for packaging foil, bottles, and fuel system applications.

Suitable nanosized particles to be present in PNCs include delaminated clay layers. Such clay-containing PNCs can be prepared by polymerising monomers in the presence of clays, as disclosed in the prior art.

Ring-opening polymersation of cyclic monomers in the presence of cationic clays, such as montmorillonite, is disclosed by B. Lepoittevin et al., Polymer 44 (2003) 2033-2040. Cationic clays are layered materials having a crystal structure consisting of negatively charged layers built up of specific combinations of tetravalent, trivalent, and optionally divalent metal hydroxides between which there are cations and water molecules. The layers of montmorillonite are built up of Si, Al, and Mg hydroxides.

According to the above disclosure, montmorillonite was stirred with ε-caprolactone and heated at 100° C. in the presence of Bu₂(MeO), the latter serving as a catalyst for ring-opening polymerisation. The extent of intercalation and/or delamination of the montmorillonite depended on the montmorillonite concentration in the caprolactone mixture and the nature of its interlayer cations.

D. Kubies et al., Macromolecules 35 (2002) 3318-3320, polymerise ε-caprolactone in the presence of Cloisite 25A (N,N,N,N-dimethyldodecyloctadecyl-ammonium montmorillonite) or N,N-diethyl-N-3-hydroxypropyloctadecylammonium bromide-exchanged montmorillonite. Tin(II) octoate or dibutyltin(IV) dimethoxide was used as catalyst.

N. Pantoustier et al., Polymer Engineering and Science 42 (2002) 1928-1937, show that ε-caprolactone can be polymerised at 170° C. in the presence of Na⁺-montmorrilonite without addition of a catalyst like tin(II) octoate or dibutyltin(IV) dimethoxide. They theorise that this is due to activation of the monomer through interaction with acidic sites on the clay surface.

U.S. Pat. No. 6,372,837 discloses the polymerisation of various monomers, in particular caprolactam, in the presence of a layered double hydroxide—also called anionic clay or hydrotalcite-like material—in which at least 20% of the total number of interlayer anions present is of organic nature and has the formula R′—RCOO⁻, R′—ROSO₃⁻, or R′—RSO₃⁻, wherein R is a straight or branched alkyl or alkyl phenyl group having 6 to 22 carbon atoms and R′ is a reactive group consisting of hydroxy, amino, epoxy, vinyl, isocyanate, carboxy, hydroxyphenyl, and anhydride. These organic anions are introduced into the layered double hydroxide by ion-exchange of an existing anionic clay or by synthesis of the layered double hydroxide in the presence of these anions.

Layered double hydroxides or anionic clays have a crystal structure consisting of positively charged layers built up of specific combinations of divalent and trivalent metal hydroxides between which there are anions and water molecules. Their layered structure corresponds to the general formula

[Mₘ²⁺Mₙ³⁺(OH)₂ₘ₊₂ₙ₋](X_{n/z}^{z-}).bH₂O

wherein M²⁺ is a divalent metal, M³⁺ is a trivalent metal, m and n have a value such that m/n=1 to 10, preferably 1 to 6, and b has a value in the range of from 0 to 10, generally a value of 2 to 6 and often a value of about 4. X^{z-} refers to the anion present in the interlayer.

For the purpose of this specification: when at least part, i.e. more than 1 wt % of the anions present in the interlayers is of organic nature, the anionic clay is defined as an organic anionic clay; when substantially all, i.e. at least 99 wt %, but preferably 100 wt %, of the total amount of anions in the interlayers is of inorganic nature, the anionic clay is defined as an inorganic anionic clay.

Conventional anionic clays are inorganic anionic clays. Hydrotalcite is an example of a naturally occurring inorganic anionic clay in which the trivalent metal is aluminium, the divalent metal is magnesium, and the predominant anion is carbonate; meixnerite is an inorganic anionic clay wherein the trivalent metal is aluminium, the divalent metal is magnesium, and the predominant anion is hydroxyl.

In order to obtain organic anionic clays, ion-exchange or modified synthesis methods are required.

It has now surprisingly been found that for successful ring-opening polymerisation and homogeneous dispersion of the anionic clay layers in a polymeric matrix, conventional, i.e. inorganic anionic clays, can be used. Intercalation with organic anions is not required.

The present invention therefore relates to a process for the preparation of a polymer-containing composition comprising the steps of

a. preparing a mixture of an inorganic anionic clay and a cyclic monomer and
b. polymerising said monomer.

As intercalation of the inorganic anionic clay with organic compounds prior to step a) is not required in this process, this process is less cumbersome and economically more feasible and attractive than the process according to U.S. Pat. No. 6,372,837.

In this specification, the term “polymer” refers to an organic substance of at least two building blocks (i.e. monomers), thereby including oligomers, copolymers, and polymeric resins.

The resulting product comprises anionic clay intercalated with polymer and/or delaminated or exfoliated anionic clay layers dispersed in the polymer.

Within the present specification intercalation is defined as an increase in the interlayer spacing of the original inorganic anionic clay. Delamination is defined as reduction of the mean stacking degree of the clay particles by at least partly de-layering the clay structure, thereby yielding a material containing significantly more individual clay particles per volume unit. Exfoliation is defined as complete delamination, i.e. disappearance of periodicity, leading to a random dispersion of individual layers in a medium, thereby leaving no stacking order at all.

Intercalation of anionic clays can be observed with X-ray diffraction (XRD), because the position of the basal reflections—i.e. the d(00L) reflections—is indicative of the distance between the layers, which distance increases upon intercalation.

Reduction of the mean stacking degree can be observed as broadening, up to disappearance, of the XRD reflections or by an increasing asymmetry of the basal reflections (hk0).

Characterisation of complete delamination, i.e. exfoliation, remains an analytical challenge, but may in general be concluded from the complete disappearance of non-(hk0) reflections from the original anionic clay. The formation of a transparent melt in step b) of the process of the invention is also an indication of exfoliation. The ordering of the layers and, hence, the extent of delamination, can further be visualised with transmission electron microscopy (TEM).

Suitable cyclic monomers for use in the process according to the present invention include (i) cyclic esters, such as ε-caprolactone, γ-valerolactone, β-butyrolactone, γ-butyrolactone, δ-valerolactone, propiolactone, pivalolactone, p-dioxanone (1,4-dioxan-2-one), 1,4-dioxepan-2-one, 1,5-dioxepan-2-one, lactide (the cyclic diester of lactic acid), and glycolide (the dimeric ester of glycolic acid), (ii) cyclic carbonates like ethylene carbonate, propylene carbonate, glycerol carbonate, and trimethylene carbonate (1,3-dioxan-2-one), (iii) lactams such as ε-caprolactam, (iv) anhydrides like N-carboxy anhydrides, (v) monoepoxides such as alkylglycidyl ethers and alkylglycidyl esters, (vi) bisepoxides such as liquid and solid Epikote resins and other bisphenol A-based epoxides, (vii) cyclic siloxane monomers, and (viii) combinations of two or more of the aforementioned monomers.

Due to their biodegradability and relatively low price, cyclic esters are the preferred cyclic monomers, with the lactones, lactide, and glycolide being specifically preferred. Examples of lactones are butyrolactones, valerolactones, and caprolactones. The lactones can be of the beta-, gamma-, delta- and/or epsilon-type. In view of their stability and availability, gamma-, delta-, and epsilon-lactones are most preferred. Specific examples of such lactones are ε-caprolactone and pivalolactone.

Suitable inorganic anionic clays for use in the process according to the present invention include inorganic anionic clays having a trivalent metal (M³⁺) selected from the group consisting of B³⁺, Al³⁺, Ga³⁺, In³⁺, Bi³⁺, Fe³⁺, Cr³⁺, Co³⁺, Sc³⁺, La³⁺, Ce³⁺, and mixtures thereof and divalent metals (M²⁺) selected from the group consisting of Mg²⁺, Ca²⁺, Ba²⁺, Zn²⁺, Mn²⁺, Co²⁺, Mo²⁺, Ni²⁺, Fe²⁺, S²⁺, Cu²⁺, and mixtures thereof. Especially preferred are Mg—Al inorganic anionic clays (such as hydrotalcite or meixnerite), Ba/Al, Ca/Al, and Zn/Al inorganic anionic clays. The exact choice depends on the application of the final product.

The charge-balancing anions present in the interlayers of the anionic clay to be mixed with the cyclic monomer in step a) are of inorganic nature. Examples of suitable charge-balancing anions are hydroxide, carbonate, bicarbonate, nitrate, chloride, bromide, sulphate, bisulphate, vanadates, tungstates, borates, phosphates, pillaring anions such as HVO₄⁻, V₂O₇⁴⁻, HV₂O₁₂⁴⁻, V₃O₉³⁻, V₁₀O₂₈⁶⁻, Mo₇O₂₄⁶⁻, PW₁₂O₄₀³⁻, B(OH)₄⁻, B₄O₅(OH)₄²⁻, [B₃O₃(OH)₄]⁻, [B₃O₃(OH)₅]²⁻ HBO₄²⁻, HGaO₃²⁻, CrO₄²⁻, and Keggin-ions. Preferred inorganic anionic clays contain carbonate, nitrate, sulphate and/or hydroxide in the interlayer, because these are the most readily available, easily obtainable, and least expensive inorganic anionic clays. For the purpose of this specification, carbonate and bicarbonate anions are defined as being of inorganic nature.

The mixture of step a) is prepared by mixing the inorganic anionic clay with the cyclic monomer. Depending on whether the cyclic monomer is liquid or solid at the mixing temperature, and depending on whether or not solvents are added (see below), this mixing results in a suspension, a paste, or a powder mixture.

The amount of anionic clay in the mixture of step a) preferably is 0.01-75 wt %, more preferably 0.05-50 wt %, even more preferably 0.1-30 wt %, based on the total weight of the mixture.

Anionic clay amounts of 10 wt % or less, preferably 1-10 wt %, more preferably 1-5 wt %, are especially advantageous for the preparation of polymer-based nanocomposites, i.e. polymer-containing compositions according to the invention that contain delaminated—up to exfoliated—anionic clay.

Anionic clay amounts of 10-50 wt % are especially advantageous for the preparation of so-called masterbatches applicable for, e.g., polymer compounding. Although the anionic clay in such masterbatches is not in general completely delaminated, further delamination may be reached in a later stage, if so desired, when blending the masterbatch with a further polymer.

Commercial inorganic anionic clay is generally delivered as free-flowing powder. No special treatment, such as drying, of such free-flowing powder is required before its use in the process according to the invention.

Even the cyclic monomer, which as a rule must be dried (e.g. over CaH₂) before its use in every day processes, does not require a drying step before its use in the process according to the invention.

In addition to the inorganic anionic clay and the cyclic monomer(s), the mixture of step a) may contain pigments, dyes, UV-stabilisers, heat-stabilisers, anti-oxidants, fillers (like hydroxyapatite, silica, graphite, glass fibres, and other inorganic materials), flame retardants, nucleating agents, impact modifiers, plasticisers, rheology modifiers, cross-linking agents, and degassing agents.

These optional addenda and their corresponding amounts can be chosen according to need.

Also solvents may be present in the mixture. Suitable solvents are all solvents that do not interfere with the polymerisation reaction. Examples of suitable solvents are ketones (like acetone, alkyl amyl ketones, methyl ethyl ketone, methyl isobutyl ketone, and diisobutyl ketone), 1-methyl-2-pyrrolidinone (NMP), dimethyl acetamide, ethers (like tetrahydrofurane, (di)ethylene glycol dimethyl ether, (di)propylene glycol dimethyl ether, methyl tert.-butyl ether, aromatic ethers, e.g. Dowtherm™, as well as higher ethers), aromatic hydrocarbons (like Solvent Naphtas (ex Dow), toluene, and xylene), dimethyl sulphoxide, hydrocarbon solvents (like alkanes and mixtures thereof such as white spirits and petroleum ethers, and halogenated solvents (like dichlorobenzene, perchloroethylene, trichloroethylene, chloroform, dichloromethane, and dichloroethane).

Reactive species not belonging to the class of cyclic monomers that can interfere with the polymerisation reaction or react with the product of the process may be added deliberately to the mixture in step a) or during step b), in order to control the molecular weight and/or the architecture of the polymers formed during the process of the invention For example, non-cyclic esters may be added, functioning as, e.g., co-monomer. Furthermore, a compound may be added that limits the average molecular weight by terminating the polymerisation process; an example of such a compound is an alcohol. It is also possible to add a reagent that has the ability to react more than once, thereby facilitating the formation of branched polymer chains or even gelled networks.

It is also possible to add polymers to the mixture in step a). Suitable polymers include aliphatic polyesters like poly(butylene succinate), poly(butylene succinate adipate), poly(hydroxybutyrate), and poly(hydroxyvalerate), aromatic polyesters like poly(ethylene terephthalate), poly(butylene terephthalate), and poly(ethylene naphthalate), poly(orthoesters), poly(ether esters) like poly(dioxanone), polyanhydrides, (meth)acrylic polymers, polyolefins, vinyl polymers like poly(vinylchloride), poly(vinylacetate), poly(ethylene oxide), poly(acrylamide) and poly(vinylalcohol), polycarbonates, polyamides, polyaramids like Twaron®, polyimides, poly(amino acids), polysaccharide-derived polymers like (modified) starches, cellulose, and xanthan, polyurethanes, polysulphones, and polyepoxides.

The polymerisation is preferably conducted by heating the mixture of inorganic anionic clay and cyclic monomer to a temperature of at least the melting point of the cyclic monomer and of the resulting polymer. Preferably, the mixture is heated to a temperature in the range 20-300° C., more preferably 50-250° C., and most preferably 70-200° C. This heating is preferably conducted for 10 seconds up to 24 hours, more preferably 1 minute to 6 hours, depending on the temperature, the type of cyclic monomer, the composition of the mixture, and the device employed. For instance, if the process is performed in an extruder, heating times in the range of seconds up to minutes can be realistically applied, depending on the temperature and the type(s) of cyclic monomer(s) employed and other components in the mixture.

The process can be conducted under inert atmosphere, e.g. N₂ atmosphere, but this is not necessary.

If desired, a polymerisation initiator or catalyst may be added to the mixture.

A polymerisation initiator is defined as a compound which is able to start ring-opening polymerisation and from which the polymeric chain grows. Examples of such initiators for ring-opening polymerisation are alcohols. A polymerisation catalyst (also called activator) is a compound that increases the growth rate of the polymeric chain. Examples of such catalysts are organometallic compounds such as tin(II) 2-ethylhexanoate (commonly referred to as tin(II) octoate), tin alkoxides (e.g. dibutyltin(IV) dimethoxide), aluminium tri-isopropoxide, and lanthanide alkoxides.

Although the inorganic anionic clay present in the process according the present invention may act as a polymerisation initiator or catalyst, the terms “polymerisation initiator” and “polymerisation catalyst” in the present specification do not include inorganic anionic clays.

Polymerisation initiators or catalysts may be present in the mixture in an amount of 0-10 wt %, more preferably O-5 wt %, even more preferably O-1 wt %, based on the weight of cyclic monomer. However, the use of such initiators or catalysts is not required and may incur additional costs and contamination of the resulting composition. Especially if medical or biodegradable applications of the resulting product are envisaged, polymerisation initiator or catalyst residues can have harmful effects. Hence, most preferably, no polymerisation initiator or catalyst is used in the process of the invention.

The process according to the invention may be conducted in various types of polymerisation equipment, such as stirred flasks, tube reactors, extruders, etc. The mixture is preferably stirred during the process in order to homogenise the contents and the temperature of the mixture.

The process according to the invention may be conducted batchwise or continuously. Suitable batch-reactors are stirred flasks and tanks, batch mixers and kneaders, blenders, batch extruders, and other agitated vessels. Suitable reactors for conducting the process in a continuous mode include tube reactors, twin- or single-screw extruders, plow mixers, compounding machines, and other suitable high-intensity mixers.

If so desired, the composition obtained from step b) may be modified in order to make it more suitable for subsequent application, for instance to improve its compatibility with the polymeric matrix into which it may subsequently be incorporated. Such modifications can include transesterification, hydrolysis, or alcoholysis of the polymer formed during the process of the present invention, or reactions with reagents that are reactive with hydroxyl groups, such as acids, anhydrides, isocyanates, epoxides, lactones, halogen acids, and inorganic acid halides in order to modify the polymeric end groups.

In a further embodiment, the composition obtained from step b), optionally after the above modification step, can be incorporated into a polymer matrix by mixing or blending said composition with a melt or solution of such matrix polymer. Suitable polymers for matrixing purpose include aliphatic polyesters like poly(butylene succinate), poly(butylene succinate adipate), poly(hydroxybutyrate), and poly(hydroxyvalerate), aromatic polyesters like poly(ethylene terephthalate), poly(butylene terephthalate), and poly(ethylene naphthalate), poly(orthoesters), poly(ether esters) like poly(dioxanone), polyanhydrides, (meth)acrylic polymers, polyolefins (e.g polyethylene, polypropylene, and copolymers thereof, vinyl polymers like poly(vinylchloride), poly(vinylacetate), poly(ethylene oxide), poly(acrylamide) and poly(vinylalcohol), polycarbonates, polyamides, polyaramids like Twaron®, polyimides, poly(amino acids), polysaccharide-derived polymers like (modified) starches, cellulose, and xanthan, polyurethanes, polysulphones, and polyepoxides.

This incorporation can result in further delamination of the intercalated or delaminated anionic clay.

The polymer-containing composition obtainable by the above process can be added to coating, ink, resin, cleaning, or rubber formulations, drilling fluids, cements or plaster formulations, or paper pulp. They can also be used in or as a thermoplastic resin, in or as a thermosetting resin, and as a sorbent.

Polymer-containing compositions obtainable by the process of the present invention comprising e.g. biocompatible polymers—such as (co)polymers of glycolide, lactide, or ε-caprolactone—can be used for the production of, e.g., adhesives, surgical and medical instruments, synthetic wound dressings and bandages, foams, (biodegradable) objects (such as bottles, tubings or linings) or films, material for controlled release of drugs, pesticides, or fertilisers, non-woven fabrics, orthoplastic casts, and porous biodegradable materials for guided tissue repair or for support of seeded cells prior to implantation.

It is also possible to heat the polymer-containing composition in order to remove the organic compounds, thereby leaving a ceramic material, e.g. a porous oxide, which can be used as or in a catalyst or sorbent composition, optionally after a shaping and/or coating step.

### DESCRIPTION OF THE FIGURES

FIG. 1 shows the XRD patterns of poly(ε-caprolactone) homopolymer (line A), commercial hydrotalcite (line B), a polymer-containing composition prepared according to the process of the present invention comprising 95 wt % of the poly(ε-caprolactone) homopolymer and 5 wt % of the hydrotalcite (line C), a polymer-containing composition prepared according to the process of the present invention comprising 90 wt % of the poly(ε-caprolactone) homopolymer and 10 wt % of the hydrotalcite (line D), and a melt-blended composition of poly(ε-caprolactone) homopolymer and the hydrotalcite (line E).

FIG. 2 shows the XRD patterns of poly(ε-caprolactone) homopolymer (line A), commercial hydrotalcite (line B), a polymer-containing composition prepared according to the process of the present invention comprising 80 wt % of the poly(ε-caprolactone) homopolymer and 20 wt % of the hydrotalcite (line C), a polymer-containing composition prepared according to the process of the present invention comprising 50 wt % of the poly(ε-caprolactone) homopolymer and 50 wt % of the hydrotalcite (line D).

FIG. 3 is a TEM image of a polymer-containing composition prepared according to the process of the present invention comprising 95 wt % of poly(ε-caprolactone) homopolymer and 5 wt % of hydrotalcite.

FIG. 4 is a TEM image of a polymer-containing composition prepared according to the process of the present invention comprising 90 wt % of poly(ε-caprolactone) homopolymer and 10 wt % of hydrotalcite.

FIG. 5 is a TEM image of a polymer-containing composition prepared according to the process of the present invention comprising 80 wt % of poly(ε-caprolactone) homopolymer and 20 wt % of hydrotalcite.

FIG. 6 is TEM image of a melt-blended composition of poly(ε-caprolactone) homopolymer and hydrotalcite (line E).

FIG. 7 is a TEM image of a polymer-containing composition of poly(ε-caprolactone) and montmorillonite, prepared by ring-opening polymerisation of ε-caprolactone in the presence of Na⁺-montmorillonite.

FIG. 8 shows the XRD patterns of a polymer-containing composition prepared according to the process of the present invention comprising 80 wt % of the poly(ε-caprolactone) homopolymer and 20 wt % of the hydrotalcite (line A), an amorphous polyester resin (line B), and a composition comprising 25 wt % of said polymer-containing composition dispersed by melt-mixing in the polyester resin (line C).

FIG. 9 shows the XRD patterns of a commercial hydrotalcite (line A), an amorphous polyester resin (line B), and a composition prepared by melt-blending said amorphous polyester resin with 5 wt % of the commercial hydrotalcite (line C).

### EXAMPLES

In the examples below, a commercially available, synthetic hydrotalcite-like compound was used. It is DHT-4A (CAS No. 11097-59-9), supplied by Kisuma Chemicals b.v., a company of Kyowa Chem. Ind. Co., Japan. The material was used as received. The ε-caprolactone monomer (ε-Cl) was purchased from Aldrich and was also used without any pre-treatment.

### Example 1

Different amounts of hydrotalcite (DHT-4A) (1, 5, 10, 20, 40 or 50 wt %) were dispersed in ε-Cl (total weight of the suspension: 100 g) in a 250 ml 3-necked round bottom flask equipped with a mechanical stirrer, a thermometer/thermostat, and a nitrogen flush.

Each reaction mixture was heated in an oil bath to 160° C. and the ε-Cl in the suspension polymerised while stirring the mixture during 4 hours.

The resulting polymer-containing compositions were semi-crystalline with melting points in the range between 20 and 60° C., as determined by means of differential scanning calorimetry.

Pure ε-Cl (as purchased) did not show any sign of thermal polymerisation within 6 hours at 160° C. in the absence of hydrotalcite.

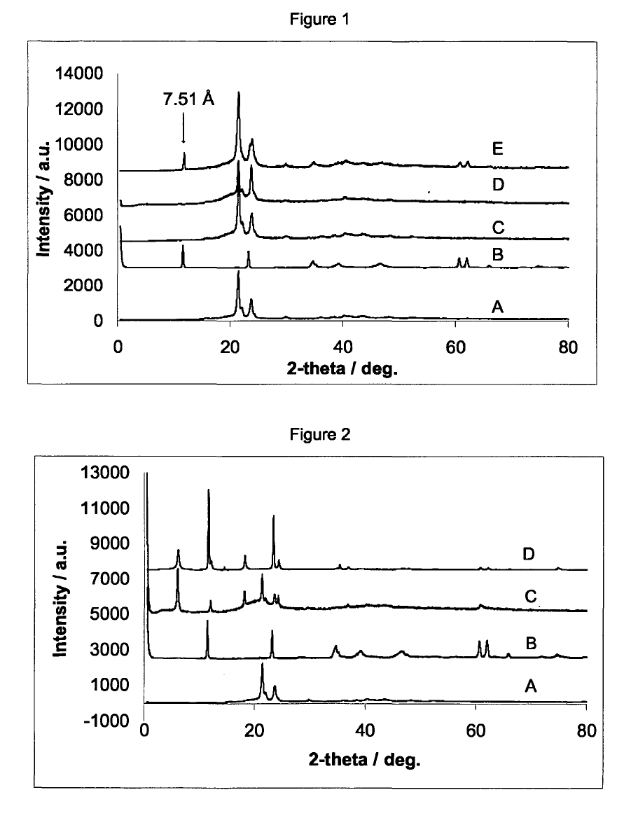

The XRD patterns of the resulting polymer-containing compositions (lines C and D) are compared with those of pure poly(ε-caprolactone) homopolymer (line A) and pure DHT-4A (line B) in FIGS. 1 and 2.

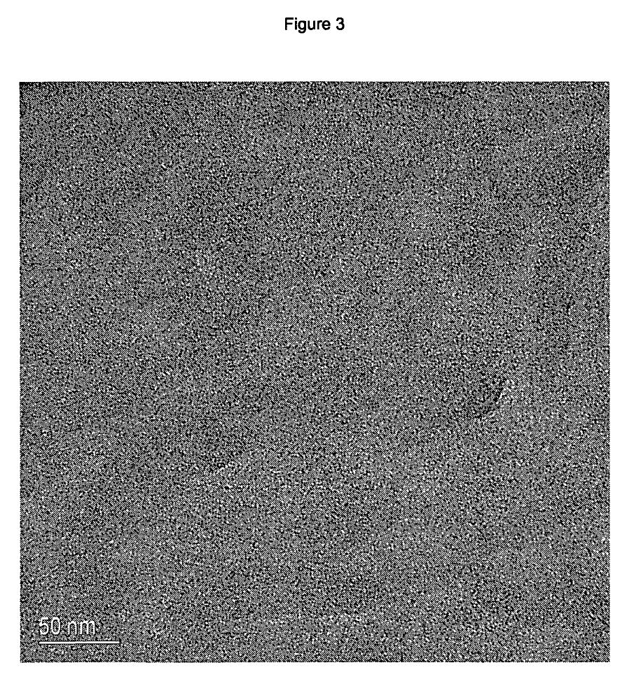

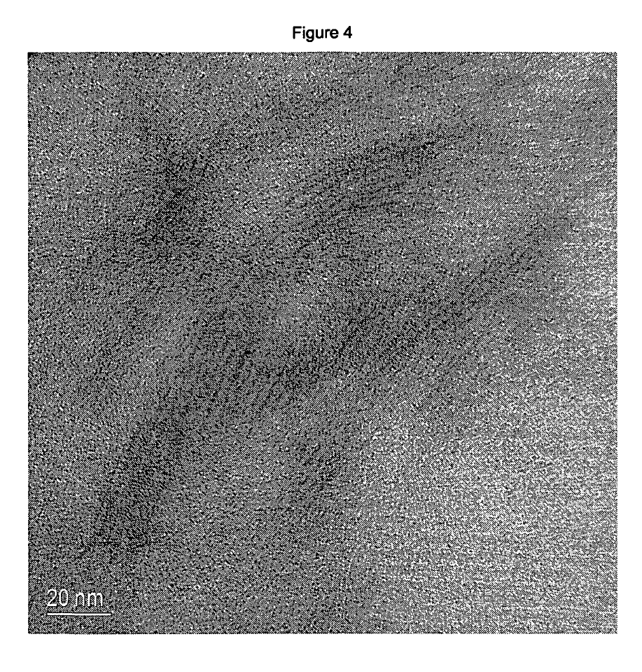

The XRD patterns of the compositions comprising up to 10 wt % of hydrotalcite (FIG. 1) do not show hydrotalcite-related non-(hk0) reflections, indicating the exfoliation of the anionic clay and, hence, the formation of a nanocomposite. This is confirmed by the TEM images (FIGS. 3 and 4) and by the fact that the reaction mixtures obtained became transparent during the process.

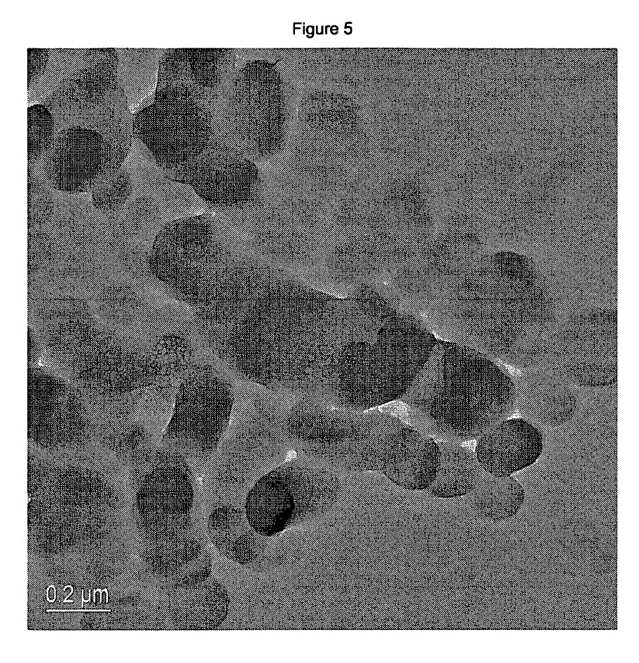

In contrast, the XRD patterns of the compositions comprising 20 and 50 wt % of hydrotalcite (FIG. 2) do show hydrotalcite-related reflections, which indicates no or at least incomplete delamination of the anionic clay. This is confirmed by the TEM image of FIG. 5 and by the fact that the reaction mixtures with 20, 40, and 50 wt % of hydrotalcite did not result in transparent melts. During the reaction these dispersions became viscous. The dispersion with 20 wt % of DHT-4A was stirred at 160° C. until the viscosity appeared to be constant. The dispersions with 40 and 50 wt % DHT-4A became too viscous to stir after 3-4 hours of heating.

From these results it can be concluded that in the composite with 20 wt % of hydrotalcite, disordering of the stacks of clay sheets is limited to swelling of the stacks, i.e., the volume fraction of hydrotalcite sheets becomes so high that sheets can only be intercalated. The intercalate exhibits a characteristic d(00L) value of 14.6 Å—which is much larger than the 7.6 Å d-spacing of the original hydrotalcite—and the XRD pattern shows many more higher order reflections. The composition comprising 50 wt % of DHT-4A was a mixture of intercalated material and the original hydrotalcite.

### Comparative Example 1

This comparative example illustrates the superiority of the process according to the invention approach, as illustrated above in Example 1, over direct melt-blending of a mixture of anionic clay with a matrix polymer. The melt-blending operation was performed in a bench model co-rotating twin-screw extruder with a volume of 5 cc (ex DSM). The screw speed was set at 150 rpm.

Poly(ε-caprolactone) homopolymer was prepared by ring-opening polymerisation of ε-Cl in bulk at 100° C. as described in the literature (See, e.g. D. Kubies et al., Macromolecules 35 (2002) 3318-3320). Initiation took the form of adding an amount of dibutyltin dimethoxide corresponding to a molar ratio of

[Bu₂Sn(OMe)_{2]}/[ε-Cl]=1/300.

A solid mixture (90/10 by weight) of the resulting semi-crystalline poly(ε-Cl) homopolymer and hydrotalcite (DHT-4A, ex. Kisuma) was added to the extruder and melt-blended at 100° C. during 15 minutes.

The resulting melt was hazy upon discharge from the extruder and the sharp reflection corresponding with a d-spacing of 7.5 Å in the XRD pattern (FIG. 1, line E) clearly reveals the presence of unaffected HTC. Increasing the melt processing time or temperature did not improve the results.

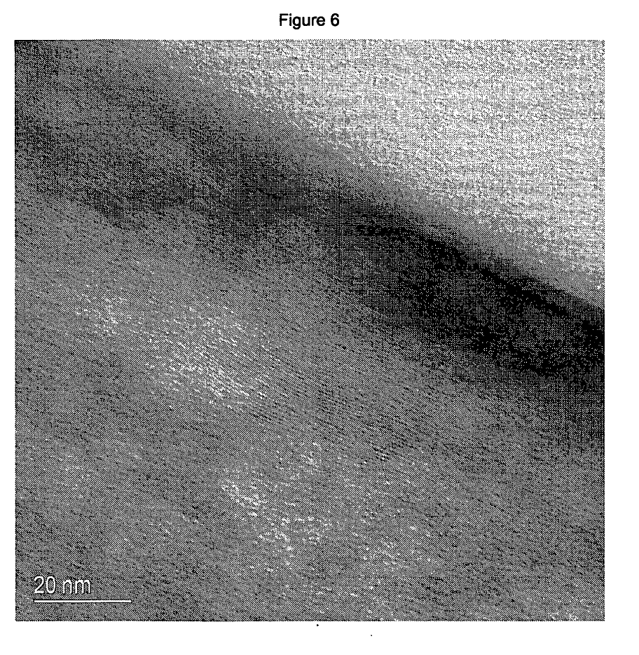

This demonstrates that poly(ε-Cl)/hydrotalcite nanocomposites cannot be prepared by simple melt-blending of hydrotalcite and poly(ε-caprolactone). This is confirmed by the TEM image of the thus prepared melt-blended composition (FIG. 6).

### Comparative Example 2

The objective of this experiment was to create a polymer-containing composition by ring-opening polymerisation of ε-Cl in the presence of Cloisite® Na⁺ (ex Southern Clay Products), a natural purified montmorillonite clay with Na⁺ as the charge balancing cation (CEC=92.6 meq/100 g clay).

5 grams of this cationic clay were dispersed in 95 grams of ε-Cl in a 250 ml 3-necked round bottom flask equipped with a mechanical stirrer, a thermometer/thermostat, and a nitrogen flush. The flask was heated in an oil bath with a temperature of 100° C. After the Cloisite was suspended in ε-Cl under stirring, dibutyltin dimethoxide ([Sn]/[ε-CL] molar ratio=1/300) was added to initiate the polymerisation that was stopped after 29 hours by allowing the reaction mixture to cool to room temperature. The polymer melt with the Cloisite Na⁺ did not become transparent during the polymerisation reaction.

Without the addition of an initiator or catalyst, ε-Cl could also be polymerised at 160° C. in the presence of Cloisite Na⁺. The polymer melt was brownish, however.

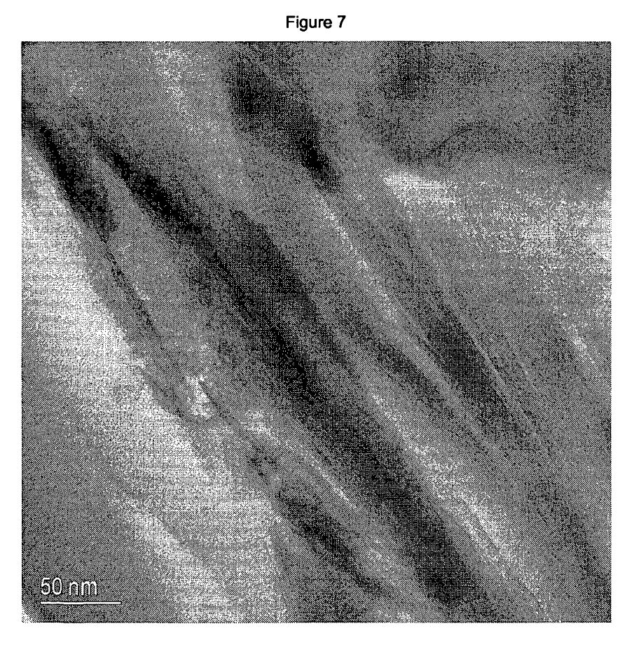

The TEM image depicted in FIG. 7 shows that the Na⁺-montmorillonite is still present as highly ordered stacks of sheets in the resulting material. Unlike in Example 1, there is no indication of intercalation or exfoliation due to the polymerisation reaction.

### Example 2

This example demonstrates that a polymer-containing composition prepared by the process of the present invention can be delaminated further and mixed homogeneously with a matrix polymer by melt-compounding in a high-shear mixer.

The matrix polymer was an amorphous polyester resin composed of the monomers terephthalic acid, adipic acid, and ethoxylated bisphenol A (Setafix P130). The glass transition temperature was 57° C. (measured by DSC) and the acid value 9 mg KOH/g resin. Melt-mixing was performed in a bench model co-rotating twin-screw extruder with a volume of 5 cc (ex DSM). The screw speed was set at 150 rpm.

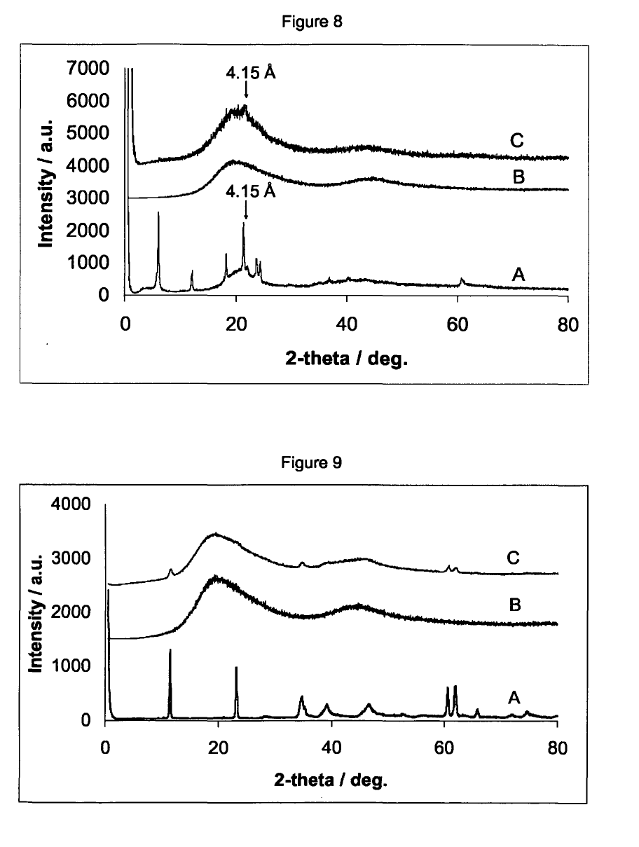

This amorphous polyester resin was melt-mixed with the polymer-containing composition comprising 20 wt % of hydrotalcite prepared in Example 1 in a ratio 80/20 (wt/wt). The resulting product contained fully delaminated (=exfoliated) clay sheets, as evidenced by the virtually complete disappearance of the reflections of the original intercalate in the XRD pattern depicted by line C in FIG. 8. The only reflections of crystalline material in the XRD pattern of this product can be assigned to semi-crystalline poly(ε-Cl) reflections, superimposed on the wide bands due to the amorphous polyester. The XRD pattern does not contain reflections that can be assigned to the original hydrotalcite.

Therefore, it can be concluded that this method results in a true polyester-anionic clay nanocomposite with a loading of about 4% of anionic clay.

### Comparative Example 3

3.8 grams of the amorphous polyester resin of Example 2 (P130) were melt-blended with 0.2 grams of hydrotalcite (DHT-4A) at 190° C. during 45 minutes using a bench model co-rotating twin-screw extruder with a volume of 5 cc (ex DSM) and a screw speed of 150 rpm. The polymer became very viscous, but not transparent. This confirms the conclusion from the XRD pattern (FIG. 9, line C) that P130 does not intercalate in unmodified HTC.

1. Process for the preparation of a polymer-containing composition comprising the steps of
a. preparing a mixture of an inorganic anionic clay and a cyclic monomer and
b. polymerising said monomer.

2. Process according to claim 1 wherein the monomer is selected from the group consisting of cyclic esters, cyclic carbonates, anhydrides, lactams, monoepoxides, bisepoxides, cyclic siloxane monomers, and combinations thereof.

3. Process according to claim 2 wherein the monomer is a cyclic ester.

4. Process according to claim 3 wherein the ester is selected from the group consisting of ε-caprolactone, γ-valerolactone, γ-butyrolactone, β-butyrolactone, glycolide, and lactide.

5. Process according to claim 1 wherein the inorganic anionic clay is hydrotalcite or meixnerite.

6. Process according to claim 1 wherein said polymerisation is conducted by heating the mixture of the day and the monomer at a temperature in the range of 50-250° C.

7. Process according to claim 1 wherein said polymerisation is conducted in the absence of a polymerisation initiator or catalyst.

8. Process according to claim 1 wherein the amount of inorganic anionic clay in the mixture of step a) is 0.01-75 wt %, based on the weight of the total mixture.

9. Process according to claim 8 wherein the mixture of step a) comprises 1-20 wt % of the clay.

10. Process according to claim 9 wherein the mixture of step a) comprises 1-10 wt % of the clay.

11. Process according to claim 1, which process is followed by chemical modification of the composition resulting from step b).

12. Process according to claim 1 wherein the mixture of step a) additionally comprises one or more polymers.

13. Process according to claim 1, which process is followed by dispersing the resulting composition in a polymeric matrix.

14. Process according to claim 12 wherein the polymer(s) is/are selected from the group consisting of polyolefins, aliphatic and aromatic polyesters, poly(ether esters), vinyl polymers, (meth)acrylic polymers, polycarbonates, polyamides, polyaramids, polyimides, poly(amino acids), polysaccharide-derived polymers, polyurethanes, polysulphones, and polyepoxides.

15. Polymer-containing composition obtainable by the process according to claim 1.

16. Process according to claim 1, further comprising the step of adding the composition resulting from step b) to a member of the group consisting of a coating, ink, cleaning, rubber, or resin formulation, drilling fluid, cement formulation, plaster formulation, or paper pulp.

17. Process according to claim 1, further comprising the step of utilizing the composition resulting from step b) in the production of a member of the group consisting of an adhesive, a surgical and medical instrument, a synthetic wound dressing or bandage, a foam, a film, a material for controlled release of a drug, pesticide, or fertiliser, a non-woven fabric, an orthoplastic cast, a sorbent, or a ceramic material.

18. Process according to claim 4 wherein the inorganic anionic clay is hydrotalcite or meixnerite.

19. Process according to claim 4 wherein said polymerisation is conducted by heating the mixture of the clay and the monomer at a temperature in the range of 50-250° C.

20. Process according to claim 4 wherein said polymerisation is conducted in the absence of a polymerisation initiator or catalyst.
